(19) United States
(12) Patent Application Publication
(10) Pub. No.: US 2009/0202824 A1
(43) Pub. Date: Aug. 13, 2009

(54) TAPE SUBSTRATE AND ADHESIVE TAPE

(75) Inventors: Mizuki Hasumi, Chiba (JP); Seiji Saita, Chiba (JP); Masaru Hasegawa, Tokyo (JP); Shigeru Suzuki, Tokyo (JP); Akira Miyama, Tokyo (JP); Ayumu Tsukamoto, Tokyo (JP); Toru Arai, Tokyo (JP)

Correspondence Address: HAHN & VOIGHT PLLC, 1012 14TH STREET, NW, SUITE 620, WASHINGTON, DC, 20005, US

(73) Assignee: DENKI KAGAKU KOGYO KABUSHIKI KAISHA, Tokyo (JP)

(21) Appl. No.: 12/302,751

(22) PCT Filed: May 22, 2007
(86) PCT No.: PCT/JP2007/060468

§ 371 Date: Dec. 12, 2008

(30) Foreign Application Priority Data
May 26, 2006 (JP) 2006-146124

(51) Int. Cl. C09J 7/02; C08L 25/02; C08F 212/06; C08L 53/00; C08L 23/08

(52) U.S. Cl. 428/343; 524/578; 526/347; 525/95; 525/240

(57) ABSTRACT

Provided are a tape substrate having excellent oil resistance as well as balanced properties of flexibility, a hand cutting property and heat resistance, and an adhesive tape using the tape substrate.

The tape substrate contains an ethylene-aromatic vinyl compound copolymer with an isotactic stereoregularity. Furthermore, the ethylene-aromatic vinyl compound copolymer is one having an alternating structure of ethylene and the aromatic vinyl compound represented by the formula (1) below, and an isotactic diad index m of Ph (an aromatic group) in the structure of the copolymer being more than 0.75:

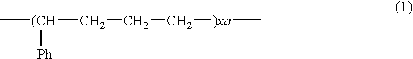

where Ph is an aromatic group and xa is the number of repeating units and an integer of at least 2.

### TECHNICAL FIELD

The present invention relates to a tape substrate using a specific ethylene-aromatic vinyl compound copolymer and an adhesive tape using the tape substrate.

### BACKGROUND ART

In the field of various types of adhesive tapes such as an insulating tape used for electrical equipment in aircrafts, ships, houses, factories, etc. in addition to vehicles such as automobiles and trains, a tape made from a resin composition containing a vinyl halide resin such as polyvinyl chloride has been used because it has adequate flexibility and stretchability, is superior in flame retardancy, mechanical strength, resistance to thermal deformation, electrical insulation property, molding processability, and so on, and is relatively inexpensive. Since such a vinyl halide resin tape produces a toxic gas during incineration, there is a recent tendency to use a tape made from a nonhalogen resin composition containing a polyolefin type resin and a large amount of an inorganic flame retardant composed of an inorganic metal compound such as an environmentally-friendly metal hydroxide (for example, magnesium hydroxide, aluminum hydroxide, or the like).

There were hitherto proposed adhesive tapes using the nonhalogen resin composition, such as an adhesive tape, a tape substrate of which is a composition of a mixture of an olefin type polymer and an inorganic type flame retardant (cf. Patent Document 1), and an adhesive tapes, a tape substrate of which is a styrene type polymer (cf. Patent Document 2), but they were sometimes unsatisfactory in terms of flexibility, a hand cutting property and abrasion resistance in use of the adhesive tape for binding complicated electrical cables in an engine room of an automobile or the like.

Furthermore, there were proposed adhesive tapes using an ethylene-styrene copolymer without stereoregularity obtained by the CGC catalyst technique (cf. Patent Documents 3 and 4), but these adhesive tapes had low oil resistance and were sometimes unsatisfactory, particularly, in use in automobile engine rooms, and in use in vehicles, factories, and so on.

### Patent Document 1: JP-A-2001-192629

### Patent Document 2: JP-A-2004-315658

### Patent Document 3: JP-A-2002-506116

### Patent Document 4: JP-A-2003-500514

### DISCLOSURE OF THE INVENTION

### Object to be Accomplished by the Invention

An object of the present invention is to provide a tape substrate having excellent oil resistance as well as balanced properties of flexibility and a hand cutting property necessary for an adhesive tape, and an adhesive tape using the tape substrate.

### Means to Accomplish the Object

The inventor of the present invention intensively and extensively studied and found that the above object was accomplished by using a resin composition containing an ethylene-aromatic vinyl compound copolymer with an isotactic stereoregularity.

The present invention is based on the above finding and has the following aspects.

1. A tape substrate comprising a resin composition containing an ethylene-aromatic vinyl compound copolymer with an isotactic stereoregularity.
2. The tape substrate according to the above 1, wherein the ethylene-aromatic vinyl compound copolymer has an alternating structure of ethylene and an aromatic vinyl compound represented by the formula (1) below, and wherein an isotactic diad index m of Ph (an aromatic group) in the structure is more than 0.75:

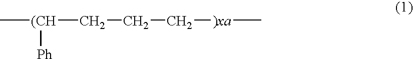

where Ph is an aromatic group and xa is the number of repeating units and an integer of at least 2.
3. The tape substrate according to the above 1 or 2, wherein the aromatic vinyl compound used for production of the ethylene-aromatic vinyl compound copolymer is styrene.
4. The tape substrate according to any one of the above 1 to 3, containing the ethylene-aromatic vinyl compound copolymer, and at least one of an aromatic vinyl compound type resin and an olefin type resin.
5. The tape substrate according to the above 4, comprising a resin composition wherein a total content of the aromatic vinyl compound type resin and/or the olefin type resin is from 1 to 100 parts by mass to 100 parts by mass of the ethylene-aromatic vinyl compound copolymer.
6. The tape substrate according to the above 4 or 5, wherein the aromatic vinyl compound type resin is at least one member selected from the group consisting of atactic polystyrene, rubber-reinforced polystyrene (HIPS), a styrene-methyl methacrylate copolymer and a styrene-imidized maleic acid copolymer.
7. The tape substrate according to any one of the above 4 to 6, wherein the olefin type resin is at least one member selected from the group consisting of isotactic polypropylene (i-PP), block polypropylene, random polypropylene and a propylene-ethylene random copolymer.
8. The tape substrate according to any one of the above 1 to 7, containing from 1 to 200 parts by mass of an inorganic filler to 100 parts by mass of the ethylene-aromatic vinyl compound copolymer.
9. The tape substrate according to any one of the above 1 to 8, wherein the ethylene-aromatic vinyl compound copolymer has an alternating structure index λ of at least 10 and at most 80.
10. An adhesive tape, having an adhesive layer formed on at least one side of the tape substrate as defined in any one of the above 1 to 9.
11. A tape for binding using the adhesive tape as defined in the above 10.

### EFFECT OF THE INVENTION

The present invention provides a tape substrate having excellent oil resistance as well as the balanced properties of flexibility and the hand cutting property, and an adhesive tape using the tape substrate.

### BRIEF DESCRIPTION OF DRAWINGS

FIG. 1 is an illustration of rac-dimethylmethylenebis(4,5-benzo-1-indenyl)zirconium dichloride used as a catalyst in Synthesis Example 1.

FIG. 2 is an illustration of a CGC (Constrained Geometry Complex) type Ti complex: (tertiary butylamide)dimethyl(tetramethyl-η5-cyclopentadienyl) silane titanium dichloride used as a catalyst in Comparative Synthesis Example 1.

### BEST MODE FOR CARRYING OUT THE INVENTION

An ethylene-aromatic vinyl compound copolymer with an isotactic stereoregularity used in the present invention (hereinafter referred to also as “the present copolymer”) will be explained below. In the specification of the present invention, a content of an aromatic vinyl compound in the present copolymer means a content of units derived from an aromatic vinyl compound monomer, in the present copolymer. Likewise, a content of ethylene means a content of units derived from an ethylene monomer, in the present copolymer.

Examples of the aromatic vinyl compound making up the present copolymer used in the present invention include styrene, various substituted styrenes such as p-methylstyrene, m-methylstyrene, o-methylstyrene, o-t-butylstyrene, m-t-butylstyrene, p-t-butylstyrene and Δ-methylstyrene, and so on. Styrene or p-methylstyrene is preferably used, and styrene is particularly preferably used, from the industrial viewpoint.

The ethylene-aromatic vinyl compound copolymer with the isotactic stereoregularity used in the present invention is a copolymer in which Ph (an aromatic group) in an alternating structure of ethylene and the aromatic vinyl compound represented by the formula (1) below, which is contained in the copolymer structure, has the isotactic stereoregularity.

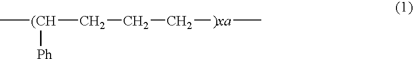

where Ph is an aromatic group such as a vinyl group and xa is the number of repeating units and an integer of at least 2.

The expression “the stereoregularity of the alternating structure of ethylene and the aromatic vinyl compound in the present copolymer has the isotactic stereoregularity” means that an isotactic diad index m (which is also called a “meso diad index”) is larger than 0.75, preferably at least 0.85 and more preferably at least 0.95. The isotactic diad index m can be obtained, for example, by the formula (2) below, from an area Ar of a peak attributable to the r structure and an area Am of a peak attributable to the m structure, of methylene carbon peaks appearing in the vicinity of 25 ppm in measurement of a nuclear magnetic resonance (¹³C-NMR) spectrum using TMS (tetramethylsilane) as a standard:

m=Am/(Ar+Am) (2)

The appearance position of the above-mentioned methylene carbon peaks might be shifted slightly depending on a kind of the aromatic vinyl compound, measurement conditions and a solvent to be used. For example, in a case where the ethylene-styrene copolymer is one using styrene which is the most preferable example among the aromatic vinyl compounds, where deuterated chloroform is used as the solvent, and where TMS is used as a standard, the peak attributable to the r structure appears in the vicinity of from 25.4 to 25.5 ppm, and the peak attributable to the m structure appears in the vicinity of from 25.2 to 25.3 ppm. Furthermore, in a case where deuterated tetrachloroethane is used as the solvent and where the center peak of triplet peaks of the deuterated tetrachloroethane (73.89 ppm) is used as a standard, the peak attributable to the r structure appears in the vicinity of from 25.3 to 25.4 ppm, and the peak attributable to the m structure appears in the vicinity of from 25.1 to 25.2 ppm. Here, the m structure represents a meso diad structure, and the r structure represents a racemic diad structure.

The present copolymer can be crystallized due to the isotactic stereoregularity of the aromatic group in the alternating structure of ethylene and the aromatic vinyl compound, and can have any structure of from a microcrystal structure to a crystal structure. Therefore, the present copolymer has excellent mechanical properties such as elastic modulus, fracture strength and elongation and excellent oil resistance.

The present copolymer is more preferably an ethylene-aromatic vinyl compound copolymer characterized in that an alternating structure index λ given by the formula (3) below is less than 80 and more than 10. The structure is determined by the nuclear magnetic resonance (the NMR method). The index λ showing a rate of the ethylene-styrene alternating structure contained in the present copolymer is defined by the formula (3) below:

λ=A₃/A₂×100 (3)

In the formula (2), A₃ is the sum of areas of three peaks a, b and c attributable to the ethylene-aromatic vinyl compound alternating structure represented by the formula (4) below, which are obtained by ¹³C-NMR measurement. A₂ is the sum of areas of peaks attributable to the main chain methylene carbon and methine carbon, which are observed in the range of from 0 to 50 ppm by ¹³C-NMR using TMS as a standard:

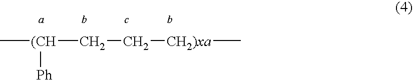

where Ph is an aromatic group such as a phenyl group, and xa is the number of repeating units and an integer of at least 2.

The alternating structure index λ of the present copolymer is preferably at most 80 and at least 10, more preferably at most 70 and at least 15. If the alternating structure index λ exceeds 80 in the present copolymer, the proportion of the alternating structure becomes so large as to cause an adverse effect of excessive crystallization. Namely, the tape substrate becomes so rigid as to lose flexibility and reduce elongation in certain cases. On the other hand, if the alternating structure index λ is less than 10, the crystal structure derived from the alternating structure becomes reduced and a polyethylene crystallinity or polystyrene chains becomes larger instead, so as to degrade mechanical properties, e.g., loss of softness, and degrade oil resistance in some cases.

In the present copolymer, a range to satisfy the condition of the alternating structure index λ of at most 80 and at least 10 corresponds to the aromatic vinyl compound content of at least 15 mol % and at most 85 mol %. When the alternating structure index λ satisfies the condition of at most 70 and at least 15, the aromatic vinyl compound content is at least 15 mol % and at most 60 mol %. If the aromatic vinyl compound content becomes larger than 60 mol %, particularly larger than 85 mol %, the chain structure of the aromatic vinyl compounds becomes large, which might result in exhibition of firmness and brittleness inadequate for the tape substrate.

A weight average molecular weight of the present copolymer is at least 30,000 and at most 1,000,000, preferably at least 100,000 and at most 500,000. If the weight average molecular weight is less than 30,000, the mechanical properties might degrade, and the film might become likely to undergo blocking to deteriorate the blocking property. If the weight average molecular weight exceeds 1,000,000, the molding processability might be deteriorated.

Production methods of the present copolymer are described, for example, in EP-0872492B1, JP-A-11-130808, JP-A-9-309925, WO02/102862 and U.S. Pat. Nos. 6,239,242, 6,579,961 and 6,451,946, and these methods are suitably applicable to the present invention. Examples of the raw material monomers for the present copolymer other than ethylene and the aromatic vinyl compound include C₃₋₂₀ α-olefins such as propylene and 1-octene, and C₃₋₄₀ cyclic olefins such as norbornene and dicyclopentadiene.

Furthermore, the present copolymer can be used in a generally grafted, denatured or modified form. The present copolymer may be one of the cross copolymers described in WO01/19881 and WO00/37517. In this case, the main chain used for the cross copolymer is preferably an ethylene-aromatic vinyl compound-diene copolymer, and particularly preferably an ethylene-styrene-divinylbenzene copolymer. The composition of the main chain is the same as the range of ethylene and the aromatic vinyl compound as described above, the diene content is from 0.001 to 1 mol %, and the total amount is 100 mol %.

A preferred production method for the ethylene-aromatic vinyl compound copolymer with the isotactic stereoregularity used in the present invention will be explained. There are no particular restrictions on the production method for the present copolymer, and the present copolymer can be obtained by copolymerizing ethylene and the aromatic vinyl compound, and, if necessary, another monomer selected from the monomers described above, in the presence of a polymerization catalyst. The polymerization catalyst most preferably used in the production of the present copolymer is a coordinated polymerization catalyst composed of a transition metal compound represented by the formula (5) below and a cocatalyst.

Use of the coordinated polymerization catalyst composed of the transition metal compound represented by the formula (5) and the cocatalyst permits us to produce the ethylene-aromatic vinyl compound copolymer with a considerably high activity and a homogeneous composition suitable for industrialization.

Furthermore, the coordinated polymerization catalyst provides a highly transparent copolymer. Yet furthermore, it provides the ethylene-aromatic vinyl compound copolymer with excellent mechanical properties, the above-mentioned isotactic stereoregularity and a head-tail styrene chain structure.

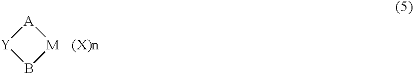

In the formula (5), each of A and B is independently a group selected from an unsubstituted or substituted benzoindenyl group, an unsubstituted or substituted cyclopentadienyl group, an unsubstituted or substituted indenyl group, and an unsubstituted or substituted fluorenyl group.

Y is a methylene group, a silylene group, an ethylene group, a germilene group or a boron atom, which has bonds with A and B and further has, as a substituent, hydrogen or a group containing a C₁₋₂₀ hydrocarbon (this group may contain from 1 to 5 atoms of nitrogen, boron, silicon, phosphorus, selenium, oxygen, fluorine, chlorine or sulfur). These substituents may be identical with or different from each other. Furthermore, Y may have a cyclic structure such as a cyclohexylidene group or a cyclopentylidene group.

Each X is independently a hydrogen atom, a halogen atom, a C₁₋₁₅ alkyl group, a C₆₋₁₀ aryl group, a C₈₋₁₂ alkyl aryl group or a silyl group having a C₁₋₄ hydrocarbon substituent, a C₁₋₁₀ alkoxy group, or an amide group having hydrogen or a C₁₋₂₂ hydrocarbon substituent n is an integer of 0, 1 or 2. M is zirconium, hafnium or titanium.

In a case where the transition metal compound represented by the formula (5) is a mixture of the racemic form and the meso form, the meso form is preferably at most 30 mol % to the entire mixture. Most preferably, the racemic form is used. The D form or the L form may also be used. Particularly preferably, at least one of A and B is an unsubstituted or substituted benzoindenyl group or an unsubstituted or substituted indenyl group. Preferred examples of the above-mentioned transition metal compound are transition metal compounds with a substituted methylene cross-linking structure which are specifically exemplified in EP-0872492A2, JP-A-11-130808 and JP-A-9-309925.

The cocatalyst to be used in the production method for the present copolymer may be one of known cocatalysts and alkylaluminum compounds conventionally used in combination with the transition metal compounds. Methylaluminoxane (or will be referred to as “methylalumoxane” or “MAO”) or a boron compound is suitably employed as the cocatalyst. Examples of the cocatalyst (methylaluminoxane or the boron compound) and the alkylaluminum compound to be used include the cocatalysts (methylaluminoxane or boron compounds) and the alkylaluminum compounds disclosed in EP-0872492A2, JP-A-11-130808, JP-A-9-309925, WO00/20426, EP-0985689A2 and JP-A-6-184179.

In the production of the ethylene-aromatic vinyl compound copolymer to be used in the present invention, the monomers and catalysts (the transition metal compound and cocatalyst) exemplified above are brought into contact, and the order and method for contact can be optionally selected from known methods. The polymerization conditions and polymerization method can be optionally selected from known ones. When the ethylene-aromatic vinyl compound copolymer suitably applicable to the present invention is defined from another point of view, the present copolymer is an ethylene-aromatic vinyl compound copolymer with an aromatic vinyl compound content of at least 15 mol % and at most 85 mol %, preferably an aromatic vinyl compound content of at least 15 mol % and at most 60 mol %, which is obtained in the presence of the coordinated polymerization catalyst composed of the transition metal compound represented by the formula (5) and the cocatalyst.

The below will describe the aromatic vinyl compound type polymer and the olefin type polymer, which can be contained in the resin composition used for the formation of the tape substrate.

### Aromatic Vinyl Compound Type Resin

The aromatic vinyl compound type resin is a homopolymer of an aromatic vinyl compound, or a copolymer containing at least one monomer component copolymerizable with the aromatic vinyl compound and having an aromatic vinyl compound content of at least 10% by mass, preferably at least 30% by mass. Examples of the aromatic vinyl compound monomer to be used for the aromatic vinyl compound type polymer include styrene, various substituted styrenes such as p-methylstyrene, m-methylstyrene, o-methylstyrene, o-t-butylstyrene, m-t-butylstyrene, p-t-butylstyrene and α-methylstyrene, and so on. Further examples are compounds with a plurality of vinyl groups in one molecule such as divinylbenzene. In addition, a copolymer among these aromatic vinyl compounds may be used. Here, the stereoregularity among the aromatic groups of the aromatic vinyl compounds may be any one of atactic, isotactic and syndiotactic forms.

Examples of the monomer copolymerizable with the aromatic vinyl compound include butadiene, isoprene, other conjugated dienes, acrylic acid, methacrylic acid, amide derivatives and ester derivatives thereof, and maleic anhydride and derivatives thereof. The copolymerization mode may be any one of block copolymerization, tapered block copolymerization, random copolymerization and alternating copolymerization. Furthermore, it is possible to use a copolymer obtained by graft-polymerizing the above aromatic vinyl compound to a polymer composed of the above monomers, and having the aromatic vinyl compound content of at least 10% by mass, preferably at least 30% by mass. When the copolymer contains butadiene or isoprene, some or all of the double bonds in the polymer main chain may be hydrogenated.

Examples of the above-mentioned aromatic vinyl compound type resin include isotactic polystyrene (i-PS), syndiotactic polystyrene (s-PS), atactic polystyrene (a-PS), rubber-reinforced polystyrene (HIPS), an acrylonitrile-butadiene-styrene copolymer (ABS resin), a styrene-acrylonitrile copolymer (AS) resin, and a styrene-methacrylate copolymer such as a styrene-methyl methacrylate copolymer, a styrene-methacrylic aid copolymer, a styrene-diene block/tapered copolymer (SBS, SIS, or the like), a hydrogenated styrene-diene block/tapered copolymer (SEBS, SEPS, or the like), a styrene-diene copolymer (SBR, or the like), a hydrogenated styrene-diene copolymer (hydrogenated SBR, or the like), a styrene-maleic acid copolymer and a styrene-imidized maleic acid copolymer. They can be used alone or in combination of two or more compounds.

The above-mentioned aromatic vinyl compound type polymer is required to have a styrene-equivalent weight average molecular weight of at least 30,000, preferably at least 50,000, in order to exhibit performance as a practical resin. In order to improve the heat resistance of the tape substrate of the present invention, the above aromatic vinyl compound type resin is preferably one with a glass transition point of at least 70° C., preferably at least 100° C. Examples of the aromatic vinyl compound type resin include atactic polystyrene (a-PS), rubber-reinforced polystyrene (HIPS), an acrylonitrile-butadiene-styrene copolymer (ABS) resin, a styrene-acrylonitrile copolymer (AS resin), a styrene-methacrylate copolymer such as a styrene-methyl methacrylate copolymer, a styrene-maleic acid copolymer, and a styrene-imidized maleic acid copolymer. More preferably, the aromatic vinyl compound type resin is atactic polystyrene (a-PS), rubber-reinforced polystyrene (HIPS), a styrene-methyl methacrylate copolymer, a styrene methacrylic acid copolymer, or a styrene-imidized maleic acid copolymer.

### Olefin Type Resin

Examples of the olefin type resin include low density polyethylene (LDPE), high density polyethylene (HDPE), linear low density polyethylene (LLDPE), isotactic polypropylene (i-PP), syndiotactic polypropylene (s-PP), atactic polypropylene (a-PP), a propylene-ethylene block copolymer, a propylene-ethylene random copolymer, an ethylene-propylene-diene copolymer (EPDM), an ethylene-vinyl acetate copolymer, polyisobutene, polybutene and a cyclic olefin polymer such as polynorbornene and a cyclic olefin copolymer such as an ethylene-norbornene copolymer. The olefin type resin may be one obtained by copolymerization of dienes such as butadiene and an diene, as the case requires. They can be used alone or in combination of two or more kinds.

The above-mentioned olefin type resin is required to have a styrene-equivalent weight average molecular weight of at least 10,000, preferably at least 30,000, in order to exhibit performance as a practical resin. The above olefin type resin is preferably one with a crystal melting point of at least 100° C., more preferably at least 130° C. in order to improve the heat resistance of the tape substrate of the present invention. Particularly preferred resins are isotactic polypropylene (i-PP), block polypropylene, random polypropylene and a propylene-ethylene random copolymer.

The aromatic vinyl compound type resin and/or the olefin type resin is blended (or incorporated) in the resin composition in order to improve the heat resistance or to adjust the elastic modulus of the tape substrate, and for this purpose, the resin composition preferably contains the ethylene-aromatic vinyl compound copolymer with the isotactic stereoregularity and at least one of the aromatic vinyl compound type resin and the olefin type resin. However, they may not be blended depending on the purpose and use of the tape substrate and the heat resistance of the ethylene-aromatic vinyl compound copolymer employed.

An amount of the aromatic vinyl compound type resin and/or the olefin type resin to be blended is preferably in a range of from 1 to 100 parts by mass and particularly preferably from 5 to 70 parts by mass in total to 100 parts by mass of the ethylene-aromatic vinyl compound copolymer with the isotactic stereoregularity. If the blending amount exceeds 100 parts by mass, the tape substrate can lose the processability, and can become rigid, so as to degrade the elongation, resistance to pinhole, and texture as the tape substrate.

An inorganic filler which can be blended in the resin composition used in the present invention will be explained. The reason why the inorganic filler is blended is that the hand cutting property of the tape substrate is improved, and the heat conduction during molding is increased to enhance a cooling effect of the tape substrate, thereby suppressing strain in the tape substrate as much as possible. An average particle size of the inorganic filler is, for example, in a range of at most 20 μm, preferably at most 10 μm. If the average particle size is less than 0.5 μm, the workability or the hand cutting property will deteriorate. On the other hand, if the average particle size exceeds 20 μm, the tensile strength and fracture elongation of the tape substrate will be decreased, and it will result in decrease of the flexibility or appearance of pinholes.

The above-mentioned average particle size is a value based on particle distribution measurement by laser diffraction. A particle distribution measuring apparatus may be, for example, “Model LS-230” (tradename) manufactured by Beckman Coulter, Inc. Furthermore, when the inorganic filler blended is a nonhalogen type retardant, a char (carbonated layer) can be formed to improve the flame retardancy of the tape substrate.

Examples of the inorganic filler include aluminum hydroxide, magnesium hydroxide, zirconium hydroxide, calcium hydroxide, potassium hydroxide, barium hydroxide, triphenyl phosphate, ammonium polyphosphate, polyphosphate amide, zirconium oxide, magnesium oxide, zinc oxide, titanium oxide, molybdenum oxide, guanidine phosphate, hydrotalcite, smectite, zinc borate, zinc borate anhydride, zinc metaborate, barium metaborate, antimony oxide, antimony trioxide, antimony pentoxide, red phosphorus, talc, alumina, silica, boehmite, bentonite, silicate soda, calcium silicate, calcium sulfate, calcium carbonate and magnesium carbonate, and one or, two or more compounds selected from these compounds are used. Particularly, it is excellent in imparting flame retardancy and economically advantageous to use at least one member selected from the group consisting of aluminum hydroxide, magnesium hydroxide, hydrotalcite and magnesium carbonate.

A blending amount of the inorganic filler is in a range of from 1 to 200 parts by mass, and preferably from 5 to 100 parts by mass to 100 parts by mass of the present copolymer. When the inorganic filler is less than 1 part by mass, the tape substrate might be inferior in the flame retardancy. On the other hand, when the inorganic filler exceeds 200 parts by mass, the tape substrate might be inferior in the mechanical properties such as processability and strength.

A plasticizer or a low-molecular weight polymer may be further added to the resin composition of the present invention if necessary. Examples of the plasticizer include well-known plasticizers, e.g., paraffin type, naphthene type or aroma type process oils, mineral oil type softening agents such as liquid paraffin, castor oil, linseed oil, olefin type waxes, mineral type waxes and various esters, and so on. Examples of the low-molecular weight polymer include a polyethylene wax, a polypropylene wax, a petroleum resin and a hydrogenated petroleum resin, and so on.

These plasticizer and low-molecular weight polymer are used for modification of the molding processability, fluidity and hardness of the tape substrate. A blending amount of the plasticizer or low-molecular weight polymer is in a range of from 0.1 to 20 parts by mass, and preferably from 0.1 to 5 parts by mass to 100 parts by mass of the ethylene-aromatic vinyl compound copolymer with the isotactic stereoregularity. If the amount of the plasticizer or low-molecular weight polymer is less than 1 part by mass, the modification of the molding processability and others for the tape substrate can be insufficient. On the other hand, if the amount exceeds 20 parts by mass, tackiness of the tape itself might deteriorate.

Furthermore, a known colorant, antioxidant, ultraviolet absorber, lubricant, stabilizer, and other additives may be optionally blended in the resin composition making up the tape substrate, as long as the effect of the present invention is not inhibited.

In the present invention, the tape substrate is generally obtained by dry-blending the ethylene-aromatic vinyl compound copolymer, the aromatic vinyl compound type resin and/or the olefin type resin, and the optional components of the inorganic filler, plasticizer and other additives, kneading the resultant resin composition by means of a Banbury mixer, a roll, an extruder, or the like, and subjecting the kneaded product to film-forming by one of known molding methods such as compression molding, calender molding, injection molding and extrusion molding.

The thickness of the tape substrate differs depending on usage of an adhesive tape, and there are no particular restrictions on the thickness of the tape substrate; it is, for example, from 40 to 500 μm, preferably from 70 to 200 μm, and further preferably from 80 to 160 μm. Furthermore, the tape substrate may have a structure of a single layer or a structure of multiple layers.

Deformation or shrinkage of the tape substrate under high temperatures can be prevented and the temperature dependency can be reduced by cross-linking with irradiation of an electron beam on the tape substrate. In this case, an irradiation dose with the electron beam is preferably in a range of from 10 to 150 Mrad (mega·rad), and particularly preferably in a range of from 15 to 25 Mrad. If the irradiation dose is less than 10 Mrad, the temperature dependency is not improved.

On the other hand, if the irradiation dose exceeds 150 Mrad, the tape substrate is deteriorated by the electron beam, whereby a problem might arise in the processability in a post-process. A cross-linking agent may be added to promote the cross-linking by the electron beam. Specifically, the cross-linking agent is preferably a low-molecular weight compound or an oligomer having at least two carbon-carbon double bonds in its molecule, and specific examples thereof include acrylate type compounds, urethane acrylate type oligomers and epoxy acrylate type oligomers.

An adhesive tape of the present invention is one having an adhesive layer formed on at least one side of the tape substrate. All the existing adhesives such as rubber type, hot-melt type, acrylic type and emulsion type adhesives may be adopted as the adhesive. Furthermore, a tackifier, an antiaging agent, a hardener, and the like may be blended in the adhesive in order to impart desired properties to the adhesive.

Preferred examples of a base polymer of the rubber type adhesives include a natural rubber, a regenerated rubber, a silicone rubber, an isoprene rubber, a styrene butadiene rubber, polyisoprene, NBR, a styrene-isoprene copolymer, a styrene-isoprene-butadiene copolymer, and so on. A cross-linking agent, softening agent, filler, flame retardant and the like may be added in the rubber type adhesives, if necessary. As specific examples, the cross-linking agent may be an isocyanate type cross-linking agent, the softening agent may be liquid rubber, the filler may be calcium carbonate, and the flame retardant may be an inorganic flame retardant such as magnesium hydroxide or red phosphorus.

The acrylic type adhesive may be a homopolymer of (meth)acrylate or a copolymer thereof with a copolymerizable monomer. Examples of the (meth)acrylate or copolymerizable monomer include alkyl esters (such as a methyl ester, an ethyl ester, a butyl ester, 2-ethylhexyl ester and an octyl ester) of (meth)acrylic acid, glycidyl ester of (meth)acrylic acid, (meth)acrylic acid, itaconic acid, maleic anhydride, (meth)acrylic acid amide, (meth)acrylic acid N-hydroxy amide, alkylaminoalkyl ester of (meth)acrylic acid (such as dimethylaminoethyl methacrylate and t-butylaminoethyl methacrylate), vinyl acetate, styrene, acrylonitrile, and so on. Among them, a main monomer is preferably an alkyl ester of acrylic acid, a homopolymer (a polymer consisting of identical monomer units) of which usually has a glass transition temperature of at most −50° C.

The tackifier resin can be selected by taking the softening point, compatibility with other components, and others into consideration. Examples thereof include a terpene resin, a rosin resin, a hydrogenated rosin resin, a cumarone-indene resin, a styrene type resin, a petroleum resin of an aliphatic type, an alicyclic type or the like, or its hydrogenated product, a terpene-phenol resin, a xylene type resin, another aliphatic hydrocarbon resin, an aromatic hydrocarbon resin, and so on.

The softening point of the tackifier resin is preferably from 65 to 170° C., and more preferable compounds to be used include a saturated alicyclic hydrocarbon resin such as a petroleum resin with the softening point of from 65 to 130° C., a polyterpene resin with the softening point of from 80 to 130° C., a glycerin ester of hydrogenated rosin with the softening point of from 80 to 130° C., and so on. They can be used in either form of a single component and a complex of two or more components.

Since the rubber type adhesive has an unsaturated double bond in the rubber molecule and is thus likely to deteriorate in the presence of oxygen and light, an antiaging agent is used in order to prevent the deterioration. Examples of the antiaging agent include a phenol type antiaging agent, an amine type antiaging agent, a benzimidazole type antiaging agent, a dithiocarbamate type antiaging agent and a phosphorus type antiaging agent, which may be used alone or as a mixture. The phenol type antiaging agent or the like is preferably used.

A curing agent for the acrylic type adhesive may be, for example, an isocyanate type, an epoxy type, an amine type, or the like, which can be used singly or as a mixture. Specific examples of the isocyanate type hardener include polyvalent isocyanate compounds such as 2,4-tolylene diisocyanate, 2,6-tolylene diisocyanate, 1,3-xylylene diisocyanate, 1,4-xylene diisocyanate, diphenylmethane-4,4′-diisocyanate, diphenylmethane-2,4′-diisocyanate, 3-methyldiphenylmethane diisocyanate, hexamethylene diisocyanate, isophorone diisocyanate, dicyclohexylmethane-4,4′-diisocyanate, dicyclohexylmethane-2,4′-diisocyanate and lysine isocyanate. The curing agent is preferably 2,4-tolylene diisocyanate, 2,6-tolylene diisocyanate, or the like.

There are no particular restrictions on a coating method of applying the adhesive, tackifier, antiaging agent, and others making up the adhesive layer of the adhesive tape, onto the tape substrate, and, for example, there is a method of applying an adhesive solution consisting of the adhesive, the tackifier, the antiaging agent and others onto one side of the tape substrate by a transfer method, and drying it.

A thickness of the adhesive layer (thickness after drying) is optionally selected within the range in which the adhesiveness and handleability are not impaired. The thickness of the adhesive layer is from 5 to 100 μm, preferably from 10 to 50 μm, though the thickness is different depending on usage of the adhesive tape. If the thickness is less than the lower limit, the adhesive force and unwinding force might be decreased. On the other hand, if the thickness is more than the upper limit, the coating efficiency might be deteriorated.

### EXAMPLES

Now, the present invention will be described in further detail with reference to Examples, but it should be noted that the present invention is by no means restricted to these Examples. The units such as “part,” “%” and others will be indicated hereinafter on the mass basis unless otherwise stated.

Analyses of copolymers obtained in the examples were carried out by the following methods.

### 13C-NMR Spectrum

The ¹³C-NMR spectrum was measured by means of α-500 manufactured by JEOL Ltd., using a deuterated 1,1,2,2-tetrachloroethane as a solvent and TMS as a standard. The measurement using TMS as a standard herein is the following measurement. Firstly, a shift value of the center peak of triplet ¹³C-NMR peaks of deuterated 1,1-2,2-tetrachloroethane was determined with respect to the standard of TMS.

Then, a copolymer was dissolved in deuterated 1,1,2,2-tetrachloroethane and the measurement of 13C-NMR was carried out for the mixture. A shift value of each peak was calculated based on the triplet center peak of deuterated 1,1,2,2-tetrachloroethane. The shift value of the triplet center peak of deuterated 1,1,2,2-tetrachloroethane was 73.89 ppm. The measurement was carried out by dissolving 3 mass/volume % of the polymer in the solvent. The 13C-NMR spectrum measurement for quantitative analysis of peak areas was carried out by a proton gated decoupling method without NOE, using a 450 pulse for a pulse width and adopting a repetition time of 5 seconds as a standard.

### 1H-NMR

A styrene content in a copolymer was determined by 1H-NMR by means of α-500 manufactured by JEOL Ltd. and AC-250 manufactured by BRUCKER Company. The copolymer was dissolved in deuterated 1,1,2,2-tetrachloroethane and the measurement was carried out in a temperature range of from 80 to 100° C. The styrene content was determined by comparison between areas of peaks attributable to phenyl protons (6.5 to 7.5 ppm) and peaks attributable to the alkyl protons (0.8 to 3 ppm) with TMS as a standard. A molecular weight was determined as a weight average molecular weight based on standard polystyrene by GPC (gel permeation chromatography). The measurement was carried out by means of HLC-8020 manufactured by TOSO CORPORATION using THF (tetrahydrofuran) as a solvent.

### DSC Measurement

The DSC measurement was carried out in a nitrogen stream by means of DSC (differential scanning calorimeter) 200 manufactured by Seiko Instruments, Inc. Namely, the DSC measurement was carried out using 10 mg of a resin composition in a temperature range of from −50° C. to 240° C. at a temperature rise rate of 10° C./min, thereby obtaining the melting point, the heat of crystal fusion and the glass transition point. The second measurement, which is usually carried out after the sample subjected to the first measurement is quenched with liquid nitrogen, was not carried out.

In Table 2 and Table 3, the “surface condition” means a condition of a surface of a tape substrate obtained, which was determined by visual observation and evaluated based on the following evaluation standards.

Excellent: clean smooth surface.

Good: surface with some fine irregularities (rough skin).

Poor: surface with irregularities (rough skin) being observed and with the thickness of the tape substrate being uneven.

In Table 2 and Table 3, the “flexibility (tensile stress at 10% elongation)” means a tensile strength at 10% modulus in the MD (longitudinal direction of the tape) measured in accordance with JIS K-6251. In an evaluation test room set at the temperature of 23±2° C. and at the humidity of 50±5% RH, test pieces (n=3 or more) of the tape substrate to be evaluated were subjected to the measurement to obtain an average value of measurement values, which was evaluated based on the following evaluation standards.

Excellent: tensile stress at 10% elongation in the range of at least 2 and less than 15 MPa.

Good: tensile stress at 10% elongation in the range of at least 0.5 and less than 2 MPa.

Poor: tensile stress at 10% elongation in the range of less than 0.5 MPa or at least 15 MPa.

In Table 2 and Table 3, the “elongation (fracture elongation)” means a tensile fracture elongation in the MD (longitudinal direction of the tape) measured in accordance with JIS K-6251. In an evaluation test room set at the temperature of 23±2° C. and at the humidity of 50±5% RH, test pieces (n=3 or more) of the tape substrate to be evaluated were subjected to the measurement to obtain an average value of measurement values, which was evaluated based on the following evaluation standards.

Good: tensile fracture elongation in the range of at least 100 and less than 400%.

Poor: tensile fracture elongation in the range of less than 100% or at least 400%.

In Table 2 and Table 3, the “hand cutting property” was evaluated as follows. A tape substrate was cut into a sample with the length of 100 mm in the MD (longitudinal direction of the tape) and a width of 20 mm in the TD (width direction of the tape), the sample of the tape substrate was then cut in the TD by human hands, and the cut condition of the cut surface was evaluated based on the following evaluation standards.

Excellent: cut surface not stretched but clearly cut.

Good: cut surface slightly stretched but clearly cut.

Poor: cut surface stretched and cut (lengthwise) in the MD (longitudinal direction of the tape).

In Table 2 and Table 3, the “heat shrinkage rate” was evaluated as follows. A tape substrate of 100 mm square was left at rest under a 110° C. atmosphere for 10 minutes and then the substrate was left at rest in an evaluation test room set at the temperature of 23±20C and at the humidity of 50±5% RH for at least 20 minutes. Thereafter, a shrinkage rate in the MD (longitudinal direction of the tape) was measured. An average value of measurement values of at least three samples (n=3 or more) was obtained as a heat shrinkage rate and evaluated in accordance with the following evaluation standards.

Excellent: shrinkage rate in the range of less than 1%.

Good: shrinkage rate in the range of at least 1% and less than 10%.

Poor: shrinkage rate in the range of at least 10%.

In Table 2 and Table 3, the “oil resistance test 1” was an oil resistance test of a tape substrate carried out in accordance with JIS K 7114. A circular test piece in a thickness of 3 mm was immersed in each of test oils (engine oil and olive oil hexane) at 23° C. and a rate of change in weight after 14 days was obtained in accordance with the following formula.

Rate of change in weight (%)=100×(weight after immersion test-weight before immersion test)/weight before immersion test

The rate of change in weight of 0% shows no change in weight, whereas a large value of the change rate shows low oil resistance to cause deformation or the like due to oil absorption (swelling). This value is preferably at most 5%.

In Table 2 and Table 3, the “oil resistance test 2” was an oil resistance test of a tape substrate carried out in accordance with JIS K 7114. A tape substrate in a thickness of 1 mm obtained by press molding at 180° C. was punched into a JIS #2 compact ½ dumbbell and it was immersed in each of test oils (engine oil and olive oil) at 23° C. It was picked up after 14 days, a tensile test was carried out to measure a fracture strength, and a retention rate of fracture strength was obtained in accordance with the following formula.

Retention rate of fracture strength (%)=100×fracture strength after immersion test/fracture strength before immersion test

The above retention rate of 100% indicates no change in the fracture strength, which is most preferable, and this value is preferably at least 50% and at most 200%.

In Table 2 and Table 3, the “oil resistance test 3” was an oil resistance test of a tape substrate carried out in accordance with JIS K 7114. The tape substrate was punched into a JIS #2 dumbbell in the MD (longitudinal direction of the tape) and it was immersed in each of test oils (engine oil and olive oil) at 23° C. It was picked up after 7 days, a tensile test was carried out to measure a fracture strength, and a retention rate of fracture strength was obtained in accordance with the following formula.

Retention rate of fracture strength (%)=100×fracture strength after immersion test/fracture strength before immersion test

The retention rate of 100% indicates no change in the fracture strength. The retention rate of 100% indicates no change in the fracture strength, which is most preferable, and this value is preferably at least 50% and at most 200%.

In Table 2 and Table 3, the “oil resistance/surface condition” was evaluated as follows. After the oil immersion, the oil on a surface of a tape substrate was wiped off and a surface condition of the tape substrate was observed. The presence or absence of stickiness was evaluated in accordance with the following evaluation standards.

Good: surface of the tape substrate without change such as swelling or depression and without stickiness.

Poor: surface of the tape substrate with change such as swelling or depression and with stickiness.

In Table 2 and Table 3, the “blocking property” was evaluated as follows. A tape substrate was cut into a shape of 50 mm×100 mm; two pieces of the substrate were superimposed in the region of 50 mm×50 mm; a load of 15 kg was exerted thereto at 50° C. for 24 hours and left at rest; and then a peeling condition of the tape substrate was evaluated in accordance with the following evaluation standards.

Good: pieces of the tape substrate adhered or bonded, but peeled off.

Poor: pieces of the tape substrate adhered or bonded and not peeled off.

### Synthesis Example 1

### Synthesis of Ethylene-Aromatic Vinyl Compound Copolymer with Isotactic Stereoregularity

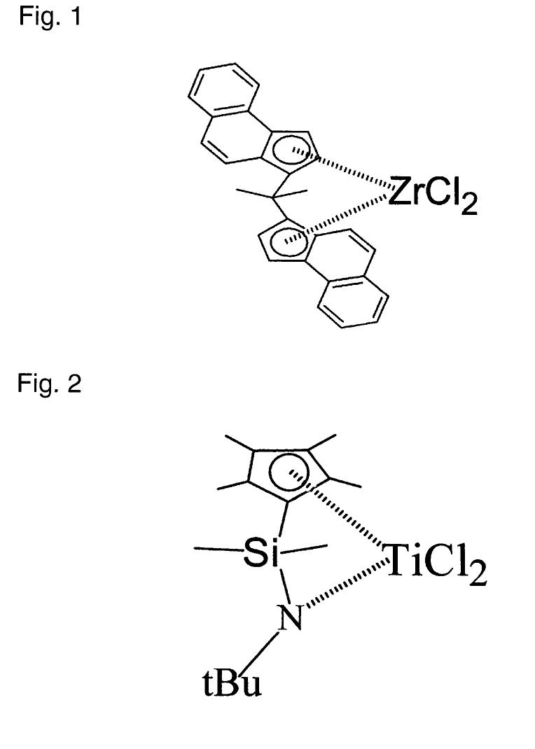

The synthesis was carried out in the following manner using as a catalyst rac-dimethylmethylenebis(4,5-benzo-1-indenyl)zirconium dichloride as shown in FIG. 1.

Polymerization was carried out by means of an autoclave with a capacity of 10 L equipped with a stirrer and a jacket for heating and cooling. 1,900 ml of styrene and 2,900 ml of cyclohexane were charged in the autoclave and stirred and heated to an internal temperature of 60° C. Next, about 100 L of nitrogen was bubbled to purge the interior of the system and the polymerization solution. Then 8.4 mmol of triisobutylaluminum and 16.8 mmol, based on Al, of methylalumoxane (MMAO-3A manufactured by TOSOH FINECHEM CORPORATION) were added, and ethylene was immediately introduced. After the pressure was stabilized at 0.98 MPa (10 Kg/cm²G), about 30 ml of a toluene solution containing 8.4 μmol of rac-dimethylmethylenebis(4,5-benzo-1-indenyl)zirconium dichloride and 0.84 mmol of triisobutylaluminum dissolved therein, was charged into the autoclave from a catalyst tank installed above the autoclave.

Next, polymerization was carried out for 60 minutes while keeping the internal temperature at 60° C. and the pressure at 1.1 Mpa. At this stage, an amount of ethylene consumed was about 200 L in a standard state. Furthermore, a conversion rate of St (styrene) at the termination of the polymerization was 30%. After completion of the polymerization, a large amount of methanol was added into the polymer solution thus obtained and was vigorously stirred by a mixer to recover the polymer. This polymer was dried in air at room temperature for a day and night, and then dried at 50° C. in vacuum until change in mass was no longer observed, whereby 800 g of polymer A (value of λ: 30, value of m>0.95) was obtained. The polymer A thus obtained was used for a production test of a tape substrate.

### Synthesis Example 2

Polymerization was carried out in the same manner as in Synthesis Example 1 except that the amount of styrene, the amount of cyclohexane, the ethylene pressure, the amount of catalyst and the polymerization period to be used were changed to 2,400 ml, 3,600 ml, 0.6 MPa, 16.8 μmol and 1 hour and 50 minutes, respectively, and 920 g of polymer B was obtained.

### Synthesis Example 3

Polymerization was carried out in the same manner as in Synthesis Example 1 except that the amount of styrene, the amount of cyclohexane, the ethylene pressure, and the polymerization period to be used were changed to 1,400 ml, 3,400 ml, 1.1 MPa and 1 hour and 40 minutes, respectively, and 630 g of polymer C was obtained. Tables 2 and 3 show analysis values of the polymers obtained in Synthesis Examples 2 and 3.

### Comparative Synthesis Example 1

### Synthesis of Ethylene-Styrene Copolymer without Substantial Stereoregularity

A catalyst used was a CGC (constrained geometry complex) type Ti complex: (tertiary butylamide) dimethyl(tetramethyl-η5-cyclopentadienyl)silane titanium dichloride shown in FIG. 2 (which will be abbreviated hereinafter as {CpMe4-SiMe2-NtBu}TiCl2).

The same operation as in Synthesis Example 1 was carried out except for the following changes: the amounts of styrene and cyclohexane charged into the autoclave were 4,000 ml and 800 ml, respectively; the polymerization temperature was 70° C.; the catalyst used was 21 μmol of {CpMe4-SiMe2-NtBu}TiCl2; the amount of methylalumoxane was 84 mmol, based on Al; the ethylene pressure and the polymerization period were 0.78 MPa (8 Kg/cm²G) and 4 hours, respectively; and 700 g of polymer D was obtained (value of λ: 27, value of m: 0.5).

Table 1 shows analysis values of the polymers A to D.

### Example 1

A tape substrate in a thickness of 0.1 mm was obtained through the following steps:

(a) step of kneading a mixture of the polymer A in Synthesis Example 1 with small amounts of a stabilizer, a lubricant (1 part by mass of erucic acid amide) and a colorant by a Banbury mixer, and making a compound with an extruder [an extruder type (single screw, cylinder size: 20 mm) manufactured by Frontier, Inc.] at a cylinder temperature of from 180 to 220° C., and

(b) step of making a film of the above compound by means of Labo Plastomill [extruder type (twin screws, cylinder size: 25 mm, L/D=25) manufactured by Toyo Seiki Seisaku-sho, Ltd.] using a coat hanger type die (width: 150 mm, lip gap: 0.15 mmt) at a cylinder temperature of from 170 to 200° C., at a die temperature of 210° C. and at a screw revolution speed of 30 rpm.

### Example 2

A tape substrate was obtained in the same manner as in Example 1, except that the polymer A in the step (a) in Example 1 was changed to the polymer B obtained in Synthesis Example 2.

### Example 3

A tape substrate was obtained in the same manner as in Example 1, except that 25 parts by mass of polystyrene (G-14L manufactured by TOYO STYRENE Co., Ltd.) was added as the aromatic vinyl compound type resin in the step (a) in Example 1.

### Example 4

A tape substrate was obtained in the same manner as in Example 1, except that 10 parts by mass of a styrene-MAA (methacrylic acid) copolymer (T-080 manufactured by TOYO STYRENE Co., Ltd.) was added as the aromatic vinyl compound type resin in the step (a) in Example 1.

### Examples 5 and 6

In Example 5 an adhesive tape was obtained in the same manner as in Example 4 except that the amount of the styrene-MAA copolymer in Example 4 was changed to 25 parts by mass. In Example 6a tape substrate was obtained in the same manner as in Example 1, except that 20 parts by mass of polystyrene (G-14L manufactured by TOYO STYRENE Co., Ltd.) and 20 parts by mass of a styrene-MAA copolymer (T-080 manufactured by TOYO STYRENE Co., Ltd.) were added in the step (a) in Example 1.

### Example 7

A tape substrate was obtained in the same manner as in Example 1, except that the polymer A in Example 1 was changed to the polymer C obtained in Synthesis Example 3 and 20 parts by mass of polystyrene (G-14L manufactured by TOYO STYRENE Co., Ltd.) and 20 parts by mass of a styrene-MAA copolymer (T-080 manufactured by TOYO STYRENE Co., Ltd.) were added.

### Example 8

A tape substrate was obtained in the same manner as in Example 1, except that 25 parts by mass of random polypropylene (E-226 manufactured by Mitsui Chemicals, Inc.) was added as the olefin type resin in the step (a) in Example 1.

### Example 9

A tape substrate was obtained in the same manner as in Example 6, except that 30 parts by mass of magnesium hydroxide (Magseeds W—H4 manufactured by Konoshima Chemical Co., Ltd., an average particle size: 5.0 μm) was added as an inorganic filler in Example 6.

### Example 10

A tape substrate was obtained in the same manner as in Example 1, except that 20 parts by mass of polystyrene (G-14L manufactured by TOYO STYRENE Co., Ltd.), 10 parts by mass of random polypropylene (E-226 manufactured by Mitsui Chemicals, Inc.) as the olefin type resin, and 10 parts by mass of magnesium hydroxide (Magseeds W—H4 manufactured by Konoshima Chemical Co., Ltd., average particle size: 5.0 μm) were added in the step (a) in Example 1.

### Comparative Example 1

A tape substrate was obtained in the same manner as in Example 1, except that the polymer A in the step (a) in Example 1 was changed to the polymer D obtained in Comparative Synthesis Example 1.

### Comparative Example 2

A tape substrate was obtained in the same manner as in Comparative Example 1, except that 20 parts by mass of each of polystyrene (G-14L manufactured by TOYO STYRENE Co., Ltd.) and a styrene-MAA copolymer (T-080 manufactured by TOYO STYRENE Co., Ltd.) were added to the polymer in Comparative Example 1.

### Examples 11 to 13

In Example 11 small amounts of other components of a stabilizer, a lubricant and a colorant were blended in the composition of the tape substrate (Example 1) in Table 4 and the resultant composition was kneaded by a Banbury mixer and calendered to form a tape substrate in a thickness of about 0.1 mm. Next, a rubber type adhesive composed of a mixture of natural rubber and SBR was applied as an adhesive onto the tape substrate, and dried, and the substrate was cut in the form of a tape with a width of 25 mm to obtain an adhesive tape.

In Example 12 and in Example 13, tape substrates in a thickness of about 0.1 mm were formed in the same manner as above by using the composition of the tape substrate in Example 6 and the composition of the tape substrate in Example 10, respectively. Then, an acrylic type adhesive was applied onto each tape, and dried, and the substrate was cut in the form of a tape with a width of 25 mm to obtain an adhesive tape.

In Table 4, the “back adhesion” was measured in accordance with JIS C 2107. In an evaluation test room set at the temperature of 23±2° C. and at the humidity of 50±5% RH, a test piece was pressure-bonded onto an SUS test plate to which an adhesive tape to be evaluated was bonded and a pressure-bonding roller was reciprocated once at a speed of 300 mm/min, followed by leaving the test piece at rest for 20 to 40 minutes. Then, the test piece was peeled off from the test plate at a speed of 300 mm/min, a numerical value of peeling force was measured, an average value of measurement values of n=3 or more was calculated as a back adhesion, and the back adhesion was evaluated in accordance with the following standards.

Good: back adhesion in the range of from 0.5 to 5.5 N/10 mm.

Poor: back adhesion in the range of less than 0.5 N/10 mm or more than 5.5 N/10 mm.

In Table 4, the “abrasion resistance” was evaluated as follows. Kanakin 3 cotton cloth as an abrasion material was placed on a tape substrate with a length of 100 mm and a width of 50 mm and a weight of 500 g was put thereon. The tape substrate and the abrasion material were rubbed together at a speed of 80 reciprocations per minute and a degree of scratch or cut was visually evaluated in accordance with the following standards.

Good: tape substrate without scratch or cut.

Poor: tape substrate with scratch or cut.

In Table 4, the “workability” was evaluated as follows. An adhesive tape was wound around an electric cable with a diameter of 1 mm and handleability was evaluated in accordance with the following standards.

Good: adhesive tape without stretch or cut during winding.

Poor: adhesive tape with stretch or cut during winding.

In Table 4, the “peeling at end” was evaluated as follows. An adhesive tape was wound around an electric cable in a half-wrap manner. The tape was cut at the end of winding and the presence or absence of peeling at the end portion was visually observed in accordance with the following standards.

Good: end portion without peeling at end.

Poor: end portion with peeling at end.

In Table 4, the “whitening” was evaluated as follows. An adhesive tape was wound around an electric cable in a half-wrap manner. The presence or absence of whitening on a cut surface at the end of winding was visually evaluated in accordance with the following standards.

Good: cut surface without whitening.

Poor: cut surface with whitening.

In Table 4, the “oil resistance” was evaluated as follows. An adhesive tape itself was used and immersed in an oil under the same conditions as in the oil resistance test 3 as described above. A tensile test in the MD (longitudinal direction of the tape) was carried out to measure a retention rate of fracture strength.

Good: retention rate of fracture strength in the range of at least 50% and at most 200%.

Poor: retention rate of fracture strength in the range of less than 50% or more than 200%.

As evident from Table 2 and Table 3, the present invention readily provides a tape substrate having excellent oil resistance as well as the balanced properties of the flexibility, the hand cutting property and the heat resistance. Furthermore, as evident from Table 4, the tape substrates possess the properties required for the adhesive tape and the binding tape, and are suitably used as adhesive tapes or binding tapes.

TABLE 1

| | | | Weight-average | Molecular | | Glass | | |
|---|---|---|---|---|---|---|---|---|
| | Polymer | Styrene | molecular | weight | Melting | transition | Value | Value |
| | name | content/mol % | weight/million | distribution | point/° C. | point/° C. | of m | of λ |
| Synthesis | A | 33 | 26 | 2.2 | 72 | −5.14 | >0.95 | 30 |
| Example 1 | | | | | | | | |
| Synthesis | B | 38 | 31 | 2.2 | 96 | 11 | >0.95 | 47 |
| Example 2 | | | | | | | | |
| Synthesis | C | 18 | 17 | 2.4 | 70 | −21 | >0.95 | 15 |
| Example 3 | | | | | | | | |
| Compara- | D | 30 | 27 | 2 | Absent | −5 | 0.5 | 27 |
| tive | | | | | | | | |
| Synthesis | | | | | | | | |
| Example 1 | | | | | | | | |

TABLE 2

| | | | Examples | | | | | |
|---|---|---|---|---|---|---|---|---|
| | | | 1 | 2 | 3 | 4 | 5 | 6 |
| Composition | Ethylene- | Polymer | A | B | A | A | A | A |
| | styrene | Composition rate | 33 | 38 | 33 | 33 | 33 | 33 |
| | copolymer | (St content)/mol % | | | | | | |
| | | Isotactic diad | >0.95 | >0.95 | >0.95 | >0.95 | >0.95 | >0.95 |
| | | index m | | | | | | |
| | | Alternating | 30 | 47 | 30 | 30 | 30 | 30 |
| | | structure index λ | | | | | | |
| | | Amount added | 100 | 100 | 100 | 100 | 100 | 100 |

| | Polystyrene (amount added) | | | 0 | 0 | 25 | 0 | 0 | 20 |
|---|---|---|---|---|---|---|---|---|---|
| | Styrene-MMA copolymer (amount | | | 0 | 0 | 0 | 10 | 25 | 20 |
| | added) | | | | | | | | |
| | Random polypropylene (amount | | | 0 | 0 | 0 | 0 | 0 | 0 |
| | added) | | | | | | | | |
| | Magnesium hydroxide (amount | | | 0 | 0 | 0 | 0 | 0 | 0 |
| | added) | | | | | | | | |
| Characteristic | Surface | | | Good | Good | Excellent | Excellent | Excellent | Excellent |
| values | condition | | | | | | | | |
| | Flexibility | MPa | | 0.7 | 1 | 5 | 3 | 6 | 7.5 |
| | (tensile | | | Good | Good | Excellent | Excellent | Excellent | Excellent |
| | stress at | | | | | | | | |
| | 10% | | | | | | | | |
| | elongation) | | | | | | | | |
| | Elongation | % | | 400 | 370 | 370 | 380 | 310 | 250 |
| | (Fracture | | | Good | Good | Good | Good | Good | Good |
| | elongation) | | | | | | | | |
| | Hand | | | Good | Excellent | Excellent | Excellent | Excellent | Excellent |
| | cutting | | | | | | | | |
| | property | | | | | | | | |
| | Thermal | % | | 20 | 20 | 4.2 | 4.5 | 0.6 | 0 |
| | shrinkage | | | Poor | Poor | Good | Good | Excellent | Excellent |
| | Oil | Weight | Engine | 2.1 | 0.9 | 1.8 | 2.2 | 2 | 1.5 |
| | resistance | increase | oil | | | | | | |
| | test 1 | rate | Olive | 3.2 | 0.9 | 2.3 | 3 | 2 | 1.8 |
| | (circular | | oil | | | | | | |
| | molded | | | | | | | | |
| | product) | | | | | | | | |
| | Oil | Retention | Engine | 120 | 140 | 110 | 120 | 100 | 100 |
| | resistance | rate of | oil | | | | | | |
| | test 2 | fracture | Olive | 140 | 180 | 110 | 110 | 110 | 120 |
| | (dumbbell) | strength % | oil | | | | | | |
| | Oil | Retention | Engine | 100 | 120 | 110 | 110 | 110 | 100 |
| | resistance | rate of | oil | | | | | | |
| | test 3 (MD | fracture | Olive | 120 | 120 | 110 | 120 | 120 | 100 |
| | direction) | strength % | oil | | | | | | |

| | | | | | | |
|---|---|---|---|---|---|---|
| Oil resistance/surface | Good | Good | Good | Good | Good | Good |
| condition | | | | | | |
| Blocking property | Excellent | Excellent | Excellent | Excellent | Excellent | Excellent |

TABLE 3

| | | | Examples | | | | Comparative Example | |
|---|---|---|---|---|---|---|---|---|
| | | | 7 | 8 | 9 | 10 | 1 | 2 |
| Composition | Ethylene- | Polymer | C | A | A | A | D | D |
| | styrene | Composition rate | 18 | 33 | 33 | 33 | 30 | 30 |
| | copolymer | (St content)/mol % | | | | | | |
| | | Isotactic diad | >0.95 | >0.95 | >0.95 | >0.95 | 0.5 | 0.5 |
| | | index m | | | | | | |
| | | Alternating | 15 | 30 | 30 | 30 | 27 | 27 |
| | | structure index λ | | | | | | |
| | | Amount added | 100 | 100 | 100 | 100 | 100 | 100 |

| | Polystyrene (amount added) | | | 20 | 0 | 20 | 20 | 0 | 20 |
|---|---|---|---|---|---|---|---|---|---|
| | Styrene-MMA copolymer (amount | | | 20 | 0 | 20 | 0 | 0 | 20 |
| | added) | | | | | | | | |
| | Random polypropylene (amount | | | 0 | 25 | 0 | 10 | 0 | 0 |
| | added) | | | | | | | | |
| | Magnesium hydroxide (amount | | | 0 | 0 | 30 | 10 | 0 | 0 |
| | added) | | | | | | | | |
| Characteristic | Surface | | | Excellent | Good | Good | Good | Poor | Excellent |
| values | condition | | | | | | | | |
| | Flexibility | MPa | | 7.3 | 7 | 10.3 | 8 | 0.6 | 6.5 |
| | (tensile | | | Excellent | Excellent | Excellent | Excellent | Good | Excellent |
| | stress at | | | | | | | | |
| | 10% | | | | | | | | |
| | elongation) | | | | | | | | |
| | Elongation | % | | 310 | 250 | 220 | 250 | 300 | 250 |
| | (Fracture | | | Good | Good | Good | Good | Good | Good |
| | elongation) | | | | | | | | |
| | Hand | | | Excellent | Excellent | Excellent | Excellent | Good | Excellent |
| | cutting | | | | | | | | |
| | property | | | | | | | | |
| | Thermal | % | | 0.3 | 3 | 0 | 1 | 25 | 2 |
| | shrinkage | | | Excellent | Good | Excellent | Excellent | Poor | Good |
| | Oil | Weight | Engine | 35 | 2.3 | 1 | 1.3 | 11 | 7 |
| | resistance | increase | oil | | | | | | |
| | test 1 | rate | Olive | 2.4 | 2.5 | 1.1 | 1.8 | 37 | 25 |
| | (circular | | oil | | | | | | |
| | molded | | | | | | | | |
| | product) | | | | | | | | |
| | Oil | Retention | Engine | 80 | 120 | 100 | 100 | 30 | 70 |
| | resistance | rate of | oil | | | | | | |
| | test 2 | fracture | Olive | 90 | 120 | 100 | 110 | 20 | 40 |
| | (dumbbell) | strength % | oil | | | | | | |
| | Oil | Retention | Engine | 70 | 100 | 100 | 100 | <20★ | <20★ |
| | resistance | rate of | oil | | | | | | |
| | test 3 (MD | fracture | Olive | 80 | 110 | 100 | 100 | ⋆immea- | ⋆Immea- |
| | direction) | strength % | oil | | | | | sureable | sureable |

| | | | | | | |
|---|---|---|---|---|---|---|
| Oil resistance/surface | Good | Good | Good | Good | Poor | Poor |
| condition | | | | | | |
| Blocking property | Excellent | Excellent | Excellent | Excellent | Poor | Good |

★Strength decreased due to swelling and there was large variation among samples
⋆Immeasurable due to swelling and semi-dissolving state

TABLE 4

| | Examples | | |
|---|---|---|---|
| | 11 | 12 | 13 |
| Composition | Example 1 | Example 6 | Example 10 |
| of tape | | | |
| substrate | | | |
| Adhesive | Rubber type | Acrylic type | Acrylic type |
| Back adhesion | 3.0 | | |
| | Good | Good | Good |
| Abrasion | Good | Good | Good |
| resistance | | | |
| Workability | Good | Good | Good |
| Peeling at | Good | Good | Good |
| end | | | |
| Oil | Good | Good | Good |
| resistance | | | |
| Whitening | Good | Good | Good |

### INDUSTRIAL APPLICABILITY

The tape substrate of the present invention is excellent in the oil resistance and the adhesive tape using the tape substrate is suitably applicable to a tape for binding to bind, for example, electric wires or cables such as wire harnesses used in a passenger compartment and engine room of an automobile.

The entire disclosure of Japanese Patent Application No. 2006-146124 filed on May 26, 2006 including specification, claims, drawings and summary are incorporated herein by reference in its entireties.

1. A tape substrate comprising a resin composition containing an ethylene-aromatic vinyl compound copolymer with an isotactic stereoregularity.

2. The tape substrate according to claim 1, wherein the ethylene-aromatic vinyl compound copolymer has an alternating structure of ethylene and an aromatic vinyl compound represented by the general formula (1) below, and wherein an isotactic diad index m of Ph (an aromatic group) in the structure is more than 0.75: 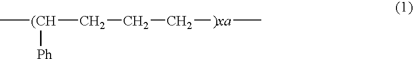
where Ph is an aromatic group, and xa is the number of repeating units and an integer of at least 2.

3. The tape substrate according to claim 1 or 2, wherein the aromatic vinyl compound used for production of the ethylene-aromatic vinyl compound copolymer is styrene.

4. The tape substrate according to claim 1, containing the ethylene-aromatic vinyl compound copolymer, and at least one of an aromatic vinyl compound type resin and an olefin type resin.

5. The tape substrate according to claim 4, comprising a resin composition wherein a total content of the aromatic vinyl compound type resin and/or the olefin type resin is from 1 to 100 parts by mass to 100 parts by mass of the ethylene-aromatic vinyl compound copolymer.

6. The tape substrate according to claim 4 or 5, wherein the aromatic vinyl compound type resin is at least one member selected from the group consisting of atactic polystyrene, rubber-reinforced polystyrene (HIPS), a styrene-methyl methacrylate copolymer and a styrene-imidized maleic acid copolymer.

7. The tape substrate according to any one of claims 4 and 5, wherein the olefin type resin is at least one member selected from the group consisting of isotactic polypropylene (i-PP), block polypropylene, random polypropylene and a propylene-ethylene random copolymer.

8. The tape substrate according to any one of claims 1-2 and 4-5, containing from 1 to 200 parts by mass of an inorganic filler to 100 parts by mass of the ethylene-aromatic vinyl compound copolymer.

9. The tape substrate according to any one of claims 1-2 and 4-5, wherein the ethylene-aromatic vinyl compound copolymer has an alternating structure index λ of at least 10 and at most 80.

10. An adhesive tape having an adhesive layer formed on at least one side of the tape substrate as defined in claims 1 to 9.

11. A tape for binding using the adhesive tape as defined in claim 10.
